(19) United States
(12) Patent Application Publication
(10) Pub. No.: US 2017/0299733 A1
(43) Pub. Date: Oct. 19, 2017

(54) TERMINAL CAPABLE OF DETECTING RAYS, ENCLOSURE, AND METHOD FOR FABRICATING TERMINAL

(71) Applicant: BOE TECHNOLOGY GROUP CO., LTD., Beijing (CN)

(72) Inventor: Xuan HE, Beijing (CN)

(73) Assignee: BOE TECHNOLOGY GROUP CO., LTD., Beijing (CN)

(21) Appl. No.: 15/323,949

(22) PCT Filed: Feb. 24, 2016
(86) PCT No.: PCT/CN2016/074442

§ 371 Date: Jan. 4, 2017

(30) Foreign Application Priority Data
Sep. 25, 2015 (CN) 201510622900.4

(51) Int. Cl. G01T 1/16; G02F 1/1333; G02F 1/13

(52) U.S. Cl. CPC G01T 1/16; G02F 1/1303; G02F 1/1333

(57) ABSTRACT

A terminal capable of detecting rays, an enclosure, and a method for fabricating terminal are provided. The terminal comprises a terminal body and a ray detector in communication with the terminal body. The terminal body comprises a display panel. The ray detector detects rays around the terminal, and transmits the detected signal to the terminal body. The terminal body analyzes the detected signal and transmits the detected signal to the display panel for displaying. In the present disclosure, the detector and the display panel are formed at the same time, and the detector is integrated in a same display panel, so that the process is simplified. The terminal stores and analyzes the data about the collected ionizing radiation dose. As a result, the radiation dose can be read in real time, and an alert can be issued instantaneously to reduce unnecessary damage.

### RELATED APPLICATIONS

The present application is the U.S. national phase entry of PCT/CN2016/074442, with an international filing date of Feb. 24, 2016, which claims the benefit of Chinese Patent Application No. 201510622900.4, filed on Sep. 25, 2015, the entire disclosures of which are incorporated herein by reference.

### TECHNICAL FIELD

The present disclosure belongs to the field of liquid crystal display manufacturing technique, and relates to a terminal capable of detecting rays, an enclosure, and a method for fabricating the terminal.

### BACKGROUND

Ionizing radiation refers to rays with a short wavelength, high frequency, and high energy. The ionizing radiation is divided into natural radiation and artificial radiation. The natural radiation mainly originates from natural radiation in the nature, such as cosmic rays, and rays from radioactive nuclide in the earth crust. The artificial radiation is mainly applied to medical imaging apparatuses, teaching and research institutions, nuclear reactors, non-destructive inspection. If the ionizing radiation is not properly protected, an accident which causes harm to a human body is prone to occur. Exposure to excessive radiation tends to cause cancer. Therefore, it is necessary to monitor the ionizing radiation in the environment and issue an alert timely, so as to effectively prevent harmful accidents.

Currently, a common device for measuring ionizing radiation comprises a thermoluminescence dosimeter, a film dosimeter, a glass dosimeter, a semiconductor dosimeter, or the like. A medical imaging staff, a non-destructive inspection staff, and a nuclear staff generally use the thermoluminescence dosimeter for detecting the radiation dose they are subject to during daily work. The thermoluminescence dosimeter operates in a manner in which defects in a crystal (e.g., LiF) are used to detect radiation. Under irradiation of rays, the crystal produces electrons and holes, which are captured by defects. Upon heating, the electrons escape and are recombined with holes to emit light. On basis of the intensity of the emitted light, the ray dose can be determined. Measuring radiation by the thermoluminescence dosimeter has a drawback in that the radiation dose cannot be displayed in real time. Instead, after a period of time elapses, the radiation dose can be obtained by heating. This is not suitable for real time prevention. The semiconductor dosimeter has advantages of a small volume, light weight, high sensitivity. However, the semiconductor detector is generally a professional detector, and is high in cost, which hinders its popular application.

The current mobile terminals (e.g., a smart phone, a smart watch, a tablet computer) are increasing in kinds and numbers, and have been used more frequently. It is found that the existing mobile terminals have increasing probabilities of breaking a screen during use. The reason mainly lies in that when a mobile terminal falls from a certain height, a tempered glass at its front side always tends to break. It is a hot spot in the art to make a display of the terminal apparatus “more resistant to break upon falling”. Many methods are proposed to solve this problem. For example, some panel manufacturer takes polyimide (PI) resin as a substrate to produce a non-glass panel.

### SUMMARY

The present disclosure provides a terminal capable of detecting rays, an enclosure, and a method for fabricating a terminal.

In an aspect, the present disclosure provides a terminal capable of detecting rays, wherein the terminal comprises a terminal body and a ray detector in communication with the terminal body, and the terminal body comprises a display panel;

the ray detector detects rays around the terminal, and transmits the detected signal to the terminal body, the terminal body analyzes the detected signal and transmits the detected signal to the display panel for displaying.

For example, the terminal comprises two or more ray detectors.

For example, the plurality of ray detectors are arranged at periphery of the display panel.

For example, the ray detector is integrated with the display panel.

For example, the ray detector is of a direct conversion type or of an indirect conversion type.

For example, the ray detector is an X-ray detector.

In another aspect, the present disclosure further provides a terminal enclosure, comprising a ray detector which is arranged on the enclosure, wherein the enclosure is provided with a space for accommodating a terminal, the terminal is accommodated in the space within the enclosure, the ray detector is operable to communicate with the terminal, and the terminal comprises a terminal body and a display panel;

wherein the ray detector detects rays around the terminal, and transmits the detected signal to the terminal; and

wherein the terminal body analyzes the detected signal and transmits the detected signal to the display panel for displaying.

For example, the ray detector is arranged on a side of the terminal enclosure.

For example, the terminal enclosure further comprises a protection device, and the protection device and the detector are arranged on a same side of the terminal enclosure.

For example, the protection device is a rubber cover.

For example, the terminal enclosure is further provided with a wireless communication device which is connected with the ray detector;

the ray detector is connected with the terminal body through the wireless communication device.

In a further aspect, the present disclosure further provides a method for fabricating a terminal capable of detecting rays, comprising steps of: forming a thin film transistor for a display panel and a thin film transistor for a detector on a substrate; forming a first protection part in a display region of the substrate, and forming a photodiode on a non-display region of the substrate; removing the first protection part in the display region, and forming a planarization insulating layer and an electrode in the display region; forming a second protection part in the display region, forming a ray detector in the non-display region, and then forming a third protection part in the non-display region; and removing the second protection part in the display region to form a display panel.

For example, the photodiode is a PIN photodiode.

In a yet further aspect, the present disclosure further provides a method for fabricating a terminal capable of detecting rays, comprising steps of: forming a thin film transistor for a detector in a non-display region of a substrate; forming a first protection part in the non-display region, and forming a thin film transistor for a display panel in a display region of the substrate; removing the first protection part in the non-display region, forming a second protection part in the display region, and forming a ray detector in the non-display region; and removing the second protection part in the display region, forming a third protection part in the non-display region, and forming a display panel.

For example, the first protection part, the second protection part and the third protection part are coated photoresist.

For example, forming the thin film transistor for the display panel and the thin film transistor for the detector on the substrate comprises: depositing a gate on the substrate; depositing a gate insulating layer; and forming an active layer, a source, and a drain.

### BRIEF DESCRIPTION OF THE DRAWINGS

FIG. 1 is a schematic view illustrating a terminal capable of detecting rays in the present disclosure;

FIG. 2 is a schematic view illustrating a terminal capable of detecting rays with an enclosure in the present disclosure;

FIG. 3 is a structural view illustrating a ray detector of an indirect conversion type; and

FIG. 4 is a structural view illustrating a ray detector of a direct conversion type.

### DETAILED DESCRIPTION OF EMBODIMENTS

The specific embodiments of the present disclosure shall be further described in the following text with reference to the figures and the embodiments. The following embodiments are only used for explaining more clearly the technical solution of the present disclosure rather than limiting the protection scope of the present disclosure.

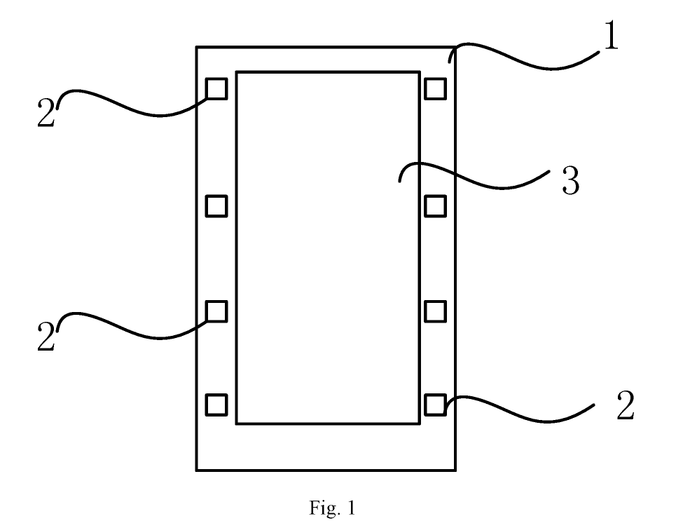

As shown in FIG. 1, the present disclosure provides a terminal capable of detecting rays. The terminal comprises a terminal body 1 and a ray detector 2 in communication with the terminal body 1. The terminal body 1 comprises a display panel 3. The ray detector 2 detects rays around the terminal, and transmits the detected signal to the terminal body 1. The terminal body 1 analyzes the detected signal and transmits to display panel 3 where the detected signal is displayed. The terminal capable of detecting rays of the present disclosure will be described in details hereinafter.

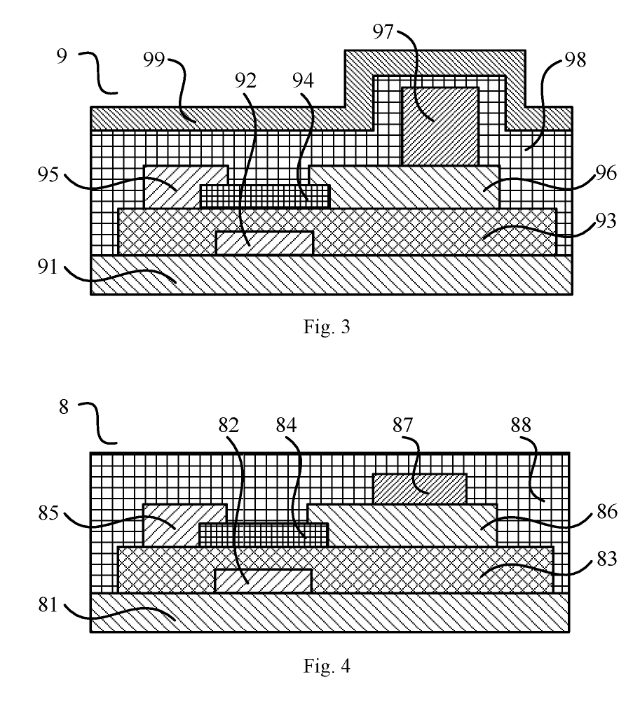

As shown in FIG. 1, in order to improve accuracy and reliability of the ray detector 2 as much as possible, the ray detector 2 for example can comprise a plurality of X-the ray detectors 2 which are arranged at an edge of the display panel 3. For example, the ray detectors 2 are uniformly distributed around the display panel 3. For purpose of decreasing production cost, simplifying process, and improving reliability, the ray detector 2 for example is integrated with the display panel 3. The ray detector 2 can either be a direct conversion type ray detector 9, as shown in FIG. 3, or an indirect conversion type ray detector 8, as shown in FIG. 4. In the direct conversion type ray detector, a detection material like amorphous silicon and amorphous selenium converts X-ray into an electrical signal The electrical signal is directly detected and processed by software, so that the detected result can be feedback to a user in real time. In the indirect conversion type ray detector, a scintillator like cesium iodide (CsI) or a phosphor like chalcogenide oxides converts X-ray into visible light. The visible light is converted into an electrical signal by a photodiode. The electrical signal is detected and read, and processed by software, so that detected result can be feedback to the user in real time.

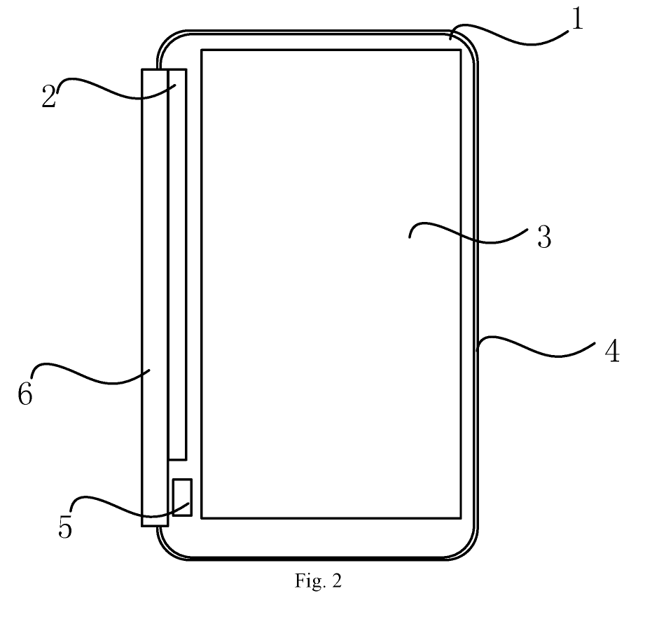

As shown in FIG. 2, in another embodiment of the present disclosure, the terminal capable of detecting rays further comprises a detachable terminal enclosure 4. The terminal enclosure 4 is provided with a space for accommodating the terminal. The terminal is accommodated in the space within the terminal enclosure 4. The ray detector 2 is arranged on the terminal enclosure 4. For example, a plurality of ray detectors 2 are arranged on a same side of the terminal enclosure 4. The terminal enclosure 4 is further provided with a wireless communication device 5 which is connected with the ray detectors 2. The wireless communication device 5 can be a Bluetooth module, a WIFI module, and any device capable of communicating with the terminal. For example, the wireless communication device 5 and the ray detectors 2 are arranged on a same side of the terminal enclosure 4. The terminal is connected with the ray detectors 2 through the wireless communication device 5. The ray signal detected by the ray detectors 2 is transmitted to the terminal through the wireless communication device 5. The terminal receives and analyzes the ray signal. In case the detected ray dose exceeds a preset dose, the terminal issues an alert signal. In order to prevent the terminal capable of detecting rays from damage upon falling during use, the terminal enclosure 4 can be further provided with a protection device 6. For example, the protection device 6 and the ray detectors 2 are arranged on a same side of the terminal enclosure 4. The protection device 6 for example is a rubber frame. The terminal enclosure 4 for example is made from a highly elastic material. For example, the position of the terminal enclosure 4 where the ray detectors 2 are arranged can be determined on basis of customs of a target user. For example, the ray detectors 2 can be arranged on a left side or right side of the terminal enclosure 4. In the present embodiment, the ray detectors 2 and the wireless communication device 5 are arranged on a same side of the terminal enclosure 4, and the terminal to which the terminal enclosure 4 has been installed changes its center of gravity. As a result, in case the terminal falls accidentally, it can always fall to the ground in a certain orientation. For example, a side of the terminal enclosure 4 on which the ray detectors 2 and the wireless communication device 5 are arranged falls to the ground firstly. Protection for the center of gravity is performed at this side, so that it is possible to prevent the terminal, especially the display panel of the terminal from breaking.

To further demonstrate benefits of the terminal capable of detecting rays in the present disclosure, the present disclosure further provides a method for fabricating the above mentioned terminal. The terminal comprises a terminal body and a ray detector in communication with the terminal body. The terminal body comprises a display panel. The method comprises steps of: forming a thin film transistor for a display panel and a thin film transistor for a detector on a substrate; forming a first protection part in a display region of the substrate, and forming a photodiode on a non-display region of the substrate; removing the first protection part in the display region, and forming a planarization insulating layer and an electrode in the display region; forming a second protection part in the display region, forming a ray detector in the non-display region, and then forming a third protection part in the non-display region; and removing the second protection part in the display region to form a display panel. The method for fabricating the terminal capable of detecting rays of the present disclosure will be described hereinafter in details.

In the present embodiment, for example the photodiode is a PIN photodiode. The protection part for the display region and the non-display region for example are coated photoresist. Particularly, as shown in FIG. 3, the method for fabricating the terminal capable of detecting rays comprises: forming a thin film transistor for a display panel and a thin film transistor for a detector at the same time on a glass substrate 91. The step of forming the thin film transistor for the display panel and the thin film transistor for the detector on the substrate 91 can comprise: forming a gate 92 on the substrate 91; forming a gate insulating layer 93 which covers the gate 92; and forming an active layer 94, a source 95, and a drain 96. Photoresist is formed in the display region as a protection part, and a PIN photodiode 97 is formed in the detector region (i.e., non-display region). The protection photoresist in the display region is removed, and a planarization insulating layer 98 and a transparent electrode (not shown) of e.g. indium tin oxide (ITO) or indium zinc oxide (IZO) are formed. The display region is again protected with photoresist, a cesium iodide layer 99 is formed in the detector region, and a protection layer (not shown) is further formed. The non-display region is protected, and the protection photoresist in the display region is removed. Subsequent processes for a LCD panel are performed normally. The above method can be used for fabricating a terminal which is an indirect conversion type ray detector. It is noted that the above method can further comprise a step of removing the protection in the non-display region.

To further demonstrate benefits of the terminal capable of detecting rays in the present disclosure, the present disclosure further provides another method for fabricating the above mentioned terminal. The terminal comprises a terminal body and a ray detector in communication with the terminal body. The terminal body comprises a display panel. The method comprises steps of: forming a thin film transistor for a detector in a non-display region of a substrate; forming a first protection part in the non-display region, and forming a thin film transistor for a display panel in a display region of the substrate; removing the first protection part in the non-display region, forming a second protection part in the display region, and forming a ray detector in the non-display region; and removing the second protection part in the display region, forming a third protection part in the non-display region, and forming a display panel. The method for fabricating the terminal capable of detecting rays of the present disclosure will be described hereinafter in details.

In the present embodiment, the protection part for the display region and the non-display region for example are coated photoresist. Particularly, as shown in FIG. 4, the method for fabricating a terminal capable of detecting rays comprises: forming a thin film transistor for a display panel and a thin film transistor for a detector on a glass substrate 81 at the same time. The step of forming the thin film transistor for the display panel and the thin film transistor for the detector on the substrate 81 can comprise: forming a gate 82 on the substrate 81, forming a gate insulating layer 83 which covers the gate 82, and forming an active layer 84, a source 85, and a drain 86. Photoresist is formed in the detector region (i.e., non-display region) as a protection part, and the thin film transistor for the display panel is formed in the display region according to a normal process for such a thin film transistor. The protection photoresist in the detector region is removed, and the display region is protected with photoresist. A detection material 87 like amorphous selenium is formed in the detector region. A planarization insulating layer 88 is formed in the detect region, a protection layer (not shown) is formed in the detector region, and the protection photoresist in the display region is removed. Subsequent processes for a display panel are performed. The method can be used for fabricating a terminal which is a direct conversion type ray detector. It is noted that the above method can further comprise a step of removing the protection layer in the detector region.

Currently in the information society, mobile terminal products (e.g., a smart phone, a smart watch, tablet computer) are popular. The face that a ray detector is combined with a common mobile product facilitates promoting and applying a radiation detection dosimeter. In this way, a common user can easily monitor the radiation around him, and can manage his health. As for professionals, like a medical imaging staff, a non-destructive inspection staff, a nuclear staff, they can monitor the radiation dose around them effectively and in real time by the mobile product they carry, and can discover the potential radiation accident as early as possible to reduce loss. In addition, this provides protection for non-professionals.

In summary, the present disclosure provides a terminal capable of detecting rays, an enclosure, and a method for fabricating the terminal. The detector and the display panel are formed at the same time, and the detector is integrated in a same display panel, so that the process is simplified. The terminal stores and analyzes the data about the collected ionizing radiation dose. As a result, the dose of the surrounding ionizing radiation can be read in real time, and is rendered visible for reading directly the radiation dose in real time. An alert can be issued instantaneously to reduce unnecessary damage. This facilitates promotion of the detector, and helps to monitor and manage of human health. A protection enclosure is provided to change the center of gravity, so that the terminal always falls to the ground in a certain orientation. A thick rubber frame is arranged at an edge to prevent a screen of the mobile apparatus from breaking.

The above contents are only the preferred embodiments of the present disclosure, and it should be pointed out that for those having ordinary skills in the art, several improvements and modifications can also be made on the premise of not diverging from the technical principles of the present disclosure, and these improvements and modifications should also be deemed as falling within the protection scope of the present disclosure.

1. A terminal capable of detecting rays, wherein the terminal comprises a terminal body and a ray detector in communication with the terminal body, and the terminal body comprises a display panel;
wherein the ray detector detects rays around the terminal, and transmits the detected signal to the terminal body, and
wherein the terminal body analyzes the detected signal and transmits the detected signal to the display panel for displaying.

2. The terminal of claim 1, wherein the terminal comprises two or more ray detectors.

3. The terminal of claim 2, wherein the ray detectors are arranged at periphery of the display panel.

4. The terminal of claim 1, wherein the ray detector is integrated with the display panel.

5. The terminal of claim 1, wherein the ray detector is of a direct conversion type or of an indirect conversion type.

6. The terminal of claim 1, wherein the ray detector is an X-ray detector.

7. A terminal enclosure, comprising a ray detector which is arranged on the enclosure, wherein the enclosure is provided with a space for accommodating a terminal, the terminal is accommodated in the space within the enclosure, the ray detector is operable to communicate with the terminal, and the terminal comprises a terminal body and a display panel;
wherein the ray detector detects rays around the terminal, and transmits the detected signal to the terminal; and
wherein the terminal body analyzes the detected signal and transmits the detected signal to the display panel for displaying.

8. The terminal enclosure of claim 7, wherein the ray detector is arranged on a side of the terminal enclosure.

9. The terminal enclosure of claim 8, wherein the terminal enclosure further comprises a protection device, and the protection device and the detector are arranged on a same side of the terminal enclosure.

10. The terminal enclosure of claim 9, wherein the protection device is a rubber cover.

11. The terminal enclosure of claim 7, wherein the terminal enclosure is further provided with a wireless communication device which is connected with the ray detector;
the ray detector is connected with the terminal body through the wireless communication device.

12. A method for fabricating the terminal of claim 1, comprising steps of:
forming a thin film transistor for a display panel and a thin film transistor for a detector on a substrate;
forming a first protection part in a display region of the substrate, and forming a photodiode on a non-display region of the substrate;
removing the first protection part in the display region, and forming a planarization insulating layer and an electrode in the display region;
forming a second protection part in the display region, forming a ray detector in the non-display region, and then forming a third protection part in the non-display region; and
removing the second protection part in the display region to form a display panel.

13. The method of claim 12, wherein the photodiode is a PIN photodiode.

14. A method for fabricating the terminal of claim 1, comprising steps of:
forming a thin film transistor for a detector in a non-display region of a substrate;
forming a first protection part in the non-display region, and forming a thin film transistor for a display panel in a display region of the substrate;
removing the first protection part in the non-display region, forming a second protection part in the display region, and forming a ray detector in the non-display region; and
removing the second protection part in the display region, forming a third protection part in the non-display region, and forming a display panel.

15. The method of claim 14, wherein the first protection part, the second protection part and the third protection part are coated photoresist.

16. The method of claim 1514, wherein forming the thin film transistor for the display panel and the thin film transistor for the detector on the substrate comprises:
depositing a gate on the substrate;
depositing a gate insulating layer; and
forming an active layer, a source, and a drain.

17. The terminal of claim 2, wherein the ray detectors are of a direct conversion type or of an indirect conversion type.

18. The terminal of claim 3, wherein the ray detectors are of a direct conversion type or of an indirect conversion type.

19. The terminal of claim 4, wherein the ray detector is of a direct conversion type or of an indirect conversion type.

20. The method of claim 12, wherein the first protection part, the second protection part and the third protection part are coated photoresist.
